(19) United States
(12) Patent Application Publication
(10) Pub. No.: US 2023/0033484 A1
(43) Pub. Date: Feb. 2, 2023

(54) INFORMATION PROCESSING APPARATUS, METHOD, AND NON-TRANSITORY RECORDING MEDIUM

(71) Applicant: Kohichi Sadano, KANAGAWA (JP)

(72) Inventor: Kohichi Sadano, KANAGAWA (JP)

(73) Assignee: Ricoh Company, Ltd., Tokyo (JP)

(21) Appl. No.: 17/810,699

(22) Filed: Jul. 5, 2022

(30) Foreign Application Priority Data
Jul. 30, 2021 (JP) 2021-125476

(51) Int. Cl. G06F 1/3234; G06F 1/3296; G06F 1/3228

(52) U.S. Cl. CPC G06F 1/3243; G06F 1/3296; G06F 1/3228

(57) ABSTRACT

An information processing apparatus includes: a first processing device; and a second processing device of which power consumption is smaller than power consumption of the first processing device. The second processing device includes circuitry to determine whether a process received by the information processing apparatus in a power saving state is executable by the second processing device, recover the second processing device from a power saving state based on a determination that the process is executable by the second processing device, and execute the process after the second processing device is recovered.

### CROSS-REFERENCE TO RELATED APPLICATIONS

This patent application is based on and claims priority pursuant to 35 U.S.C. § 119(a) to Japanese Patent Application No. 2021-125476, filed on Jul. 30, 2021, in the Japan Patent Office, the entire disclosure of which is hereby incorporated by reference herein.

### BACKGROUND

### Technical Field

The present disclosure relates to an information processing apparatus, a method, and a non-transitory recording medium.

### Description of the Related Art

A known information processing apparatus switches its operation state to a power saving mode while an operation or a process is not performed to reduce power consumption. When a process is requested in the power saving mode, the information processing apparatus switches the operation state to a normal operation mode and executes the process.

A technology has been developed to further efficiently reduce power consumption when the apparatus is recovered from the power saving mode.

### SUMMARY

Example embodiments of the present disclosure include an information processing apparatus that includes a first processing device; and a second processing device of which power consumption is smaller than power consumption of the first processing device. The second processing device includes circuitry that determines whether a process received by the information processing apparatus in a power saving state is executable by the second processing device, recovers the second processing device from a power saving state based on a determination that the process is executable by the second processing device, and executes the process after the second processing device is recovered.

Example embodiments of the present disclosure include a method executed by an information processing apparatus including a first processing device and a second processing device of which power consumption is smaller than power consumption of the first processing device. The method includes determining whether a process received by the information processing apparatus in a power saving state is executable by the second processing device, recovering the second processing device from a power saving state when the determining determinates that the process is executable by the second processing device, and executing the process after the second processing device is recovered.

Example embodiments of the present disclosure include a non-transitory recording medium storing a plurality of instructions which, when executed by one or more processors on an information processing apparatus including a first processing device and a second processing device of which power consumption is smaller than power consumption of the first processing device, causes the processors to perform a method. The method includes determining whether a process received by the information processing apparatus in a power saving state is executable by the second processing device, recovering the second processing device from a power saving state when the determining determines that the process is executable by the second processing device, and executing the process after the second processing device is recovered.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram schematically illustrating a hardware configuration of a whole system according to a present embodiment;

FIG. 2 is a diagram illustrating a hardware configuration included in an image forming apparatus according to the present embodiment;

FIG. 3 is a block diagram illustrating software included in the image forming apparatus according to the present embodiment;

FIG. 4 is a sequence diagram illustrating a process that requires recovery from a power saving mode according to the present embodiment;

FIG. 5 is a sequence diagram illustrating a process that requires recovery from a power saving mode according to a modification of the present embodiment; and

FIG. 6 is a sequence diagram illustrating a process that requires recovery from a power saving mode according to a modification of the present embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a”, “an”, and “the” are intended to include the plural forms as well, unless the context clearly indicates otherwise.

The present disclosure is described with reference to the following embodiments; however, the present disclosure is not limited to the embodiments described herein. In each of figures described below, the same reference numerals are used to refer to common elements, and the description thereof will be omitted as appropriate.

While an image forming apparatus 100 is described as an example of an information processing apparatus in the embodiment described below, no limitation is intended thereby, and various information processing apparatuses can be employed.

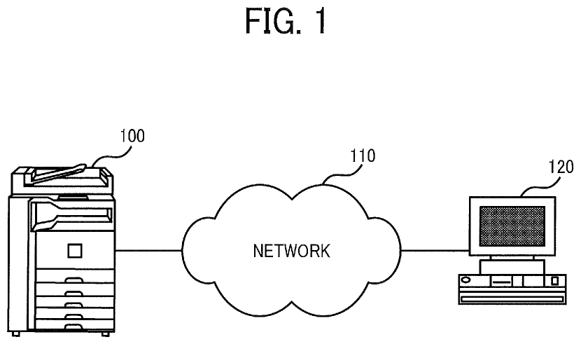

FIG. 1 illustrates an example of an image forming apparatus 100 to implement an embodiment of the present disclosure. The image forming apparatus 100 is connected to a personal computer terminal 120 via a network 110 and can perform a process such as printing or scanning. A method of connecting the image forming apparatus 100 or the personal computer terminal 120 to the network 110 may be either wired or wireless. Referring to FIG. 1, the image forming apparatus 100 is illustrated as an example of the information processing apparatus; however, no limitation is intended thereby.

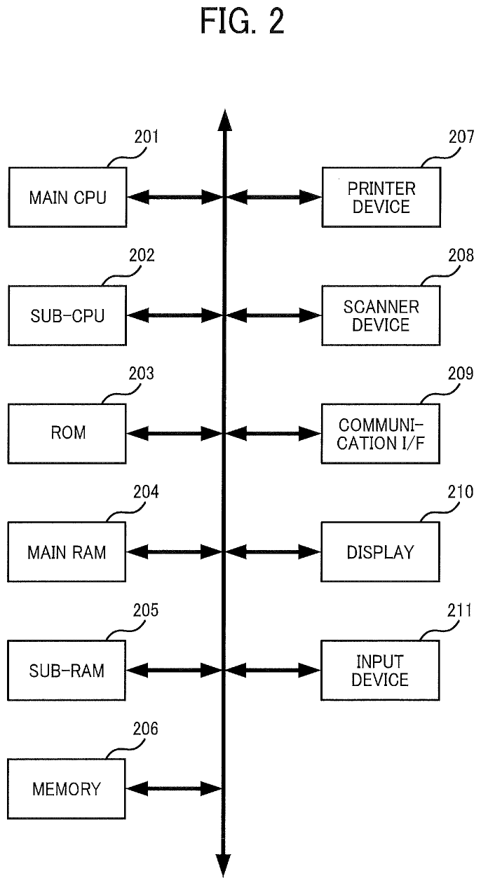

A hardware configuration of the image forming apparatus 100 is described next. FIG. 2 is a diagram illustrating a hardware configuration included in the image forming apparatus 100 according to the present embodiment. As illustrated in FIG. 2, the image forming apparatus 100 includes a main central processing unit (CPU) 201, a sub-CPU 202, a read-only memory (ROM) 203, a main random access memory (RAM) 204, a sub-RAM 205, a memory 206, a printer device 207, a scanner device 208, a communication I/F 209, a display 210, and an input device 211, which are coupled to one another via a bus.

The main CPU 201 includes a processing device such as a processor, and controls operations of components and an overall operation of the image forming apparatus 100. The main CPU 201 has a power saving function, transitions to a power saving mode under a predetermined transition condition, and stops the operation.

The sub-CPU 202 includes a processing device such as a processor, and controls operations of components and an overall operation of the image forming apparatus 100 in a period in which the main CPU 201 is stopped by the power saving function. In one example, the sub-CPU 202 may have a power saving function of stopping a function other than the function of executing the process related to the operation.

The ROM 203 is a non-volatile storage device for storing a program, firmware, and so forth to be executed in the image forming apparatus 100.

The main RAM 204 includes, for example, a volatile semiconductor storage device such as a dynamic random access memory (DRAM), and is used as a work area of the main CPU 201. Various programs to be executed by the main CPU 201 and various parameters are read from the ROM 203 and deployed in the main RAM 204.

The sub-RAM 205 includes, for example, a volatile semiconductor storage device such as a static random access memory (SRAM), and is used as a work area of the sub-CPU 202. Various programs to be executed by the sub-CPU 202 in a power saving state and various parameters are read from the ROM 203 and deployed in the sub-RAM 205.

The memory 206 is a readable and writable non-volatile storage device that stores an operating system (OS) and various types of software that cause the image forming apparatus 100 to function, setting information, and various data. Examples of the memory 206 include a hard disk drive (HDD) and a solid state drive (SSD). In one example, the memory 206 may include the ROM 203.

The printer device 207 forms an image on a sheet of paper by a laser method or an inkjet method. The scanner device 208 reads an image of a print and converts the image into data. For example, the image forming apparatus 100 can copy a print through cooperation of the scanner device 208 and the printer device 207.

The communication I/F 209 connects the image forming apparatus 100 to the network 110 and enables communication with other apparatuses via the network 110. Communication via the network 110 may be either wired communication or wireless communication, and various data can be transmitted and received using a predetermined communication protocol such as transmission control protocol/Internet protocol (TCP/IP).

The display 210 displays various data and the state of the image forming apparatus 100 to a user. Examples of the display 210 include a liquid crystal display (LCD). The input device 211 allows the user to operate the image forming apparatus 100. Examples of the input device 211 include a button. The display 210 and the input device 211 may be separate devices, or may be integrated into one device as in the case of a touch panel display.

In the present embodiment, the main CPU 201 has a higher processing capacity than the sub-CPU 202. The power consumption of the sub-CPU 202 according to the present embodiment is lower than the power consumption of the main CPU 201 in a normal state (a state that is not in the power saving mode).

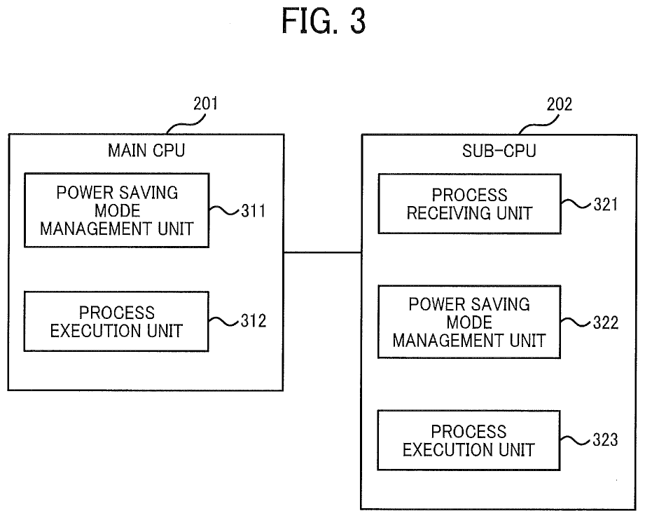

The hardware configuration included in the image forming apparatus 100 according to the present embodiment has been described above. Next, functional units executed by each hardware of the image forming apparatus 100 according to the present embodiment will be described with reference to FIG. 3. FIG. 3 is a block diagram of software included in the image forming apparatus 100 according to the present embodiment.

As illustrated in FIG. 3, the main CPU 201 according to the present embodiment includes modules of a power saving mode management unit 311 and a process execution unit 312. The sub-CPU 202 of the present embodiment includes modules of a process receiving unit 321, a power saving mode management unit 322, and a process execution unit 323.

The process receiving unit 321 receives various processes when the image forming apparatus 100 is in the power saving state. Examples of processes received by the process receiving unit 321 include an operation on the input device 211, and reception of a packet from the outside of the image forming apparatus 100 via the network 110. However, no limitation is intended thereby. The process receiving unit 321 of the present embodiment determines the content of the received process, and determines whether the process is executed in the sub-CPU 202 or in the main CPU 201.

The power saving mode management unit 311 of the main CPU 201 and the power saving mode management unit 322 of the sub-CPU 202 switch between the power saving mode and the normal mode.

The process execution unit 312 of the main CPU 201 and the process execution unit 323 of the sub-CPU 202 execute the process received by the process receiving unit 321.

The software blocks described above correspond to functional units implemented by the main CPU 201 or the sub-CPU 202 executing a program of the present embodiment to cause each hardware to function. In any one of the above-described embodiments, all of the above-described functional units of the image forming apparatus 100 may be implemented by software, hardware, or a combination of software and hardware.

The image forming apparatus 100 according to the present embodiment may include, for example, a functional unit relating to an image forming process in addition to the software blocks illustrated in FIG. 3.

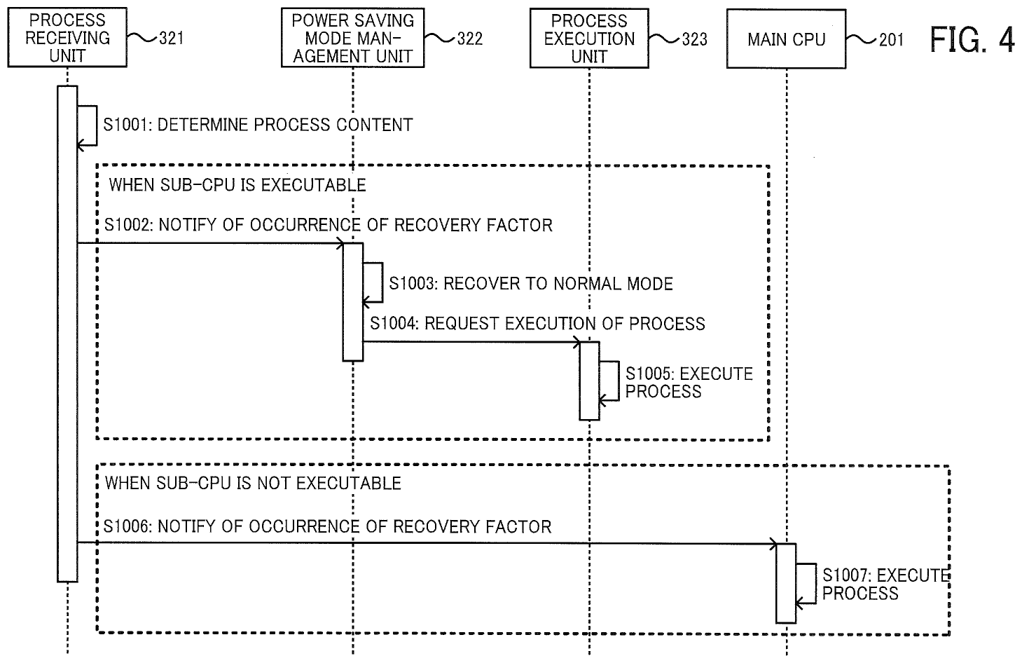

Next, a recovery process that is performed by each functional unit of the image forming apparatus 100 according to the present embodiment is described referring to FIG. 4. FIG. 4 is a sequence diagram illustrating a process that requires recovery from the power saving mode according to the present embodiment. It is assumed that the image forming apparatus 100 according to the embodiment is in the power saving mode at the time of starting the process in FIG. 4. In the sub-CPU 202 in the power saving mode according to the present embodiment, functions other than the function of executing the process for receiving the recovery process are suspended.

When the user performs an operation on the image forming apparatus 100 in the power saving state, in step S1001, the process receiving unit 321 having received the process determines whether the process is executable in the sub-CPU 202 based on the process content related to the operation. The process received by the process receiving unit 321 is not limited to an operation by the user, and may be, for example, reception of a packet. The determination in step S1001 can be made based on, for example, the magnitude of the amount of processing. For example, when the amount of processing is smaller than a predetermined threshold value, the process receiving unit 321 can determine that the process is executable in the sub-CPU 202. In one example, the determination in step S1001 may be made based on the type of packet or the type of requested process. In this case, the sub-CPU 202 stores list information indicating the type of packet or the type of request that can be processed in the sub-CPU 202, and it can be determined that the process is executable in the sub-CPU 202 when receiving the packet included in the list information. For example, it is determined that a packet that can be replied based on information stored in the memory accessible by the sub-CPU 202, such as a packet for confirming that the image forming apparatus 100 is connected to the network or a packet for confirming the state of the image forming apparatus 100, is executable in the sub-CPU 202.

When the processing is executable in the sub-CPU 202, the following steps S1002 to S1005 are performed. In step S1002, the process receiving unit 321 notifies the power saving mode management unit 322 of that a factor of recovery from the power saving mode has occurred. In step S1003, the power saving mode management unit 322 having received the notification causes the sub-CPU 202 to be recovered from the power saving mode to the normal mode, and activates the process execution unit 323. After the sub-CPU 202 is recovered to the normal mode, in step S1004, the power saving mode management unit 322 requests the process execution unit 323 to execute the process received by the process receiving unit 321. In step S1005, the process execution unit 323 having received the request executes the process.

In contrast, when determining that the process is not executable in the sub-CPU 202, in step S1006, the process receiving unit 321 notifies the main CPU 201 of that a factor of recovery from the power saving mode has occurred. Then, in step S1007, the power saving mode management unit 311 of the main CPU 201 recovers the main CPU 201 to the normal mode, and the process execution unit 312 executes the process.

With the process illustrated in FIG. 4, it is possible to change whether the process is executed in the sub-CPU 202 or in the main CPU 201 in accordance with the content. When the process is executable in the sub-CPU 202, the process is executable without recovering the main CPU 201 having relatively large power consumption, thereby reducing power consumption.

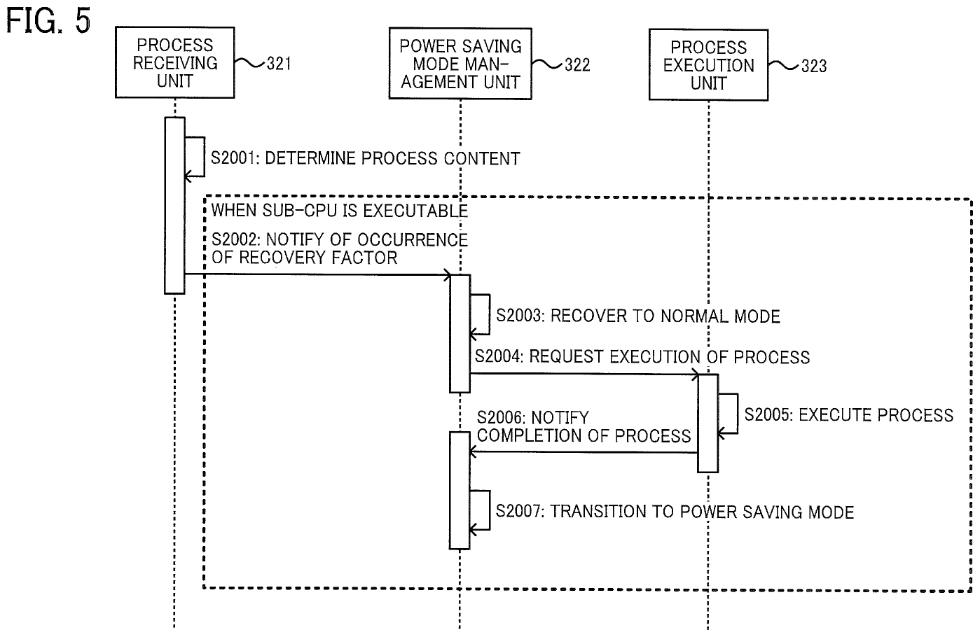

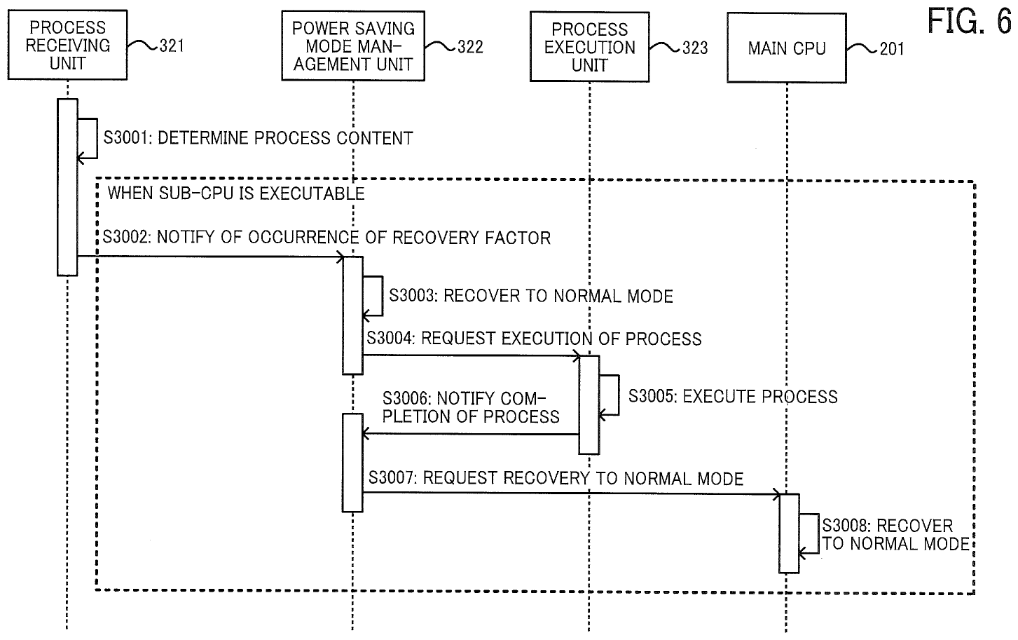

Modifications of the embodiment illustrated in FIG. 4 are described next referring to FIGS. 5 and 6. FIGS. 5 and 6 are sequence diagrams illustrating processes that require recovery from the power saving mode according to the modifications of the present embodiment.

FIG. 5 is described first. Steps S2001 to S2005 in FIG. 5 are similar to steps S1001 to S1005 in FIG. 4, and hence the details are omitted. The process when the process is not executable in the sub-CPU 202 is similar to that in FIG. 4, and hence the details are omitted.

In the modification of the embodiment illustrated in FIG. 5, after the process is executed in step S2005, the process execution unit 323 notifies the power saving mode management unit 322 of completion of the process in step S2006. In step S2007, the power saving mode management unit 322 having received the notification causes the sub-CPU 202 to transition to the power saving mode again. Thus, power consumption after execution of the process can be reduced.

FIG. 6 is described next. Steps S3001 to S3005 in FIG. 6 are similar to steps S1001 to S1005 in FIG. 4, and hence the details are omitted. The process when the process is not executable in the sub-CPU 202 is similar to that in FIG. 4, and hence the details are omitted.

When a process that requires recovery from the power saving mode is input, a new process may be subsequently input. Thus, in the modification of the embodiment illustrated in FIG. 6, the main CPU 202 is recovered to the normal mode after the sub-CPU 201 executes the process. Thus, after executing the process in step S3005, the process execution unit 323 notifies the power saving mode management unit 322 of completion of the process in step S3006. In step S3007, the power saving mode management unit 322 having received the notification requests the main CPU 201 to be recovered to the normal mode. When the main CPU 201 receives the request, in step S3008, the power saving mode management unit 311 of the main CPU 201 recovers the main CPU 201 to the normal mode, and waits for reception of a new process. Thus, the main CPU 201 is switched to the normal mode and can stand by. Hence, the time to activate the main CPU 201 can be reduced even when a new process is input thereafter.

With the above-described various processes, the image forming apparatus 100 according to the present embodiment can reduce power consumption in the recovery process from the power saving mode and can improve convenience.

In the embodiments described above, the image forming apparatus is described as an example of the information processing apparatus; however, no limitation is intended thereby, and any information processing apparatus can be employed.

The embodiments described above are particularly effective for an information processing apparatus such as an image forming apparatus including two processing devices including a processing device (for example, main CPU 201) that performs main control of the apparatus and a processing device (for example, sub-CPU 202) that performs auxiliary control (in a normally energized state).

As described above, according to the embodiments of the present disclosure, it is possible to provide the information processing apparatus, the method, and the non-transitory recording medium capable of reducing power consumption in the recovery process from the power saving mode.

Each of the functions in the above-described embodiments of the present disclosure can be implemented by a device executable program written in any one of C, C++, C#, Java (registered trademark), and the like. The program in the present embodiment can be stored and distributed in any one of device-readable non-transitory storage media that include a hard disk drive, a compact disc read-only memory (CD-ROM), a magneto-optical drive (MO), a digital versatile disc (DVD), a flexible disk, an electrically erasable programmable read-only memory (EEPROM), an erasable programmable read-only memory (EPROM), and the like. In addition, the program in the present embodiment can be transmitted in a format, which allows another device, to use via a network.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus comprising:
a first processing device; and
a second processing device of which power consumption is smaller than power consumption of the first processing device,
the second processing device including circuitry configured to
determine whether a process received by the information processing apparatus in a power saving state is executable by the second processing device,
recover the second processing device from a power saving state based on a determination that the process is executable by the second processing device, and
execute the process after the second processing device is recovered.

2. The information processing apparatus of claim 1,
wherein the circuitry is configured to
determine whether the process is executable by the second processing device based on an amount of processing by which the process is executed.

3. The information processing apparatus of claim 1,
wherein the circuitry is configured to
recover the first processing device from a power saving state and cause the first processing device to execute the process based on a determination that the process is not executable by the second processing device.

4. The information processing apparatus of claim 1,
wherein the circuitry is configured to
switch the second processing device to the power saving state after the second processing device executes the process.

5. The information processing apparatus of claim 1,
wherein the circuitry is configured to
recover the first processing device from a power saving state after the second processing device executes the processing.

6. A method executed by an information processing apparatus including a first processing device and a second processing device of which power consumption is smaller than power consumption of the first processing device, the method comprising:
determining whether a process received by the information processing apparatus in a power saving state is executable by the second processing device,
recovering the second processing device from a power saving state when the determining determines that the process is executable by the second processing device, and
executing the process after the second processing device is recovered.

7. A non-transitory recording medium storing a plurality of instructions which, when executed by one or more processors on an information processing apparatus including a first processing device and a second processing device of which power consumption is smaller than power consumption of the first processing device, causes the processors to perform a method, the method comprising:
determining whether a process received by the information processing apparatus in a power saving state is executable by the second processing device,
recovering the second processing device from a power saving state when the determining determines that the process is executable by the second processing device, and
executing the process after the second processing device is recovered.
